(19) United States
(12) Patent Application Publication
(10) Pub. No.: US 2026/0252931 A1
(43) Pub. Date: Aug. 27, 2026

(54) APPARATUS AND METHOD FOR MANAGING SPIN-MOTION ENTANGLEMENT

(71) Applicant: Oxford Ionics Limited, Begbroke (GB)

(72) Inventors: Robert Tyler SUTHERLAND, Austin, TX (US); Roland MATT, Kidlington (GB)

(21) Appl. No.: 19/062,453

(22) Filed: Feb. 25, 2025

(51) Int. Cl. G06N 10/20; G06N 10/40

(52) U.S. Cl. CPC G06N 10/20; G06N 10/40

(57) ABSTRACT

A method of performing a quantum operation performed on a quantum device comprising at least one pair of quantum qubit crystals, the method comprising: setting a detuning value of each qubit crystal to a first value, wherein the detuning value is a difference between a frequency of a gate field of the at least one pair of qubit crystals and a frequency of a motional mode of the at least one pair of qubit crystals; ramping down the detuning value according to a ramping function such that the detuning value is decreased from the first value to a second value; ramping up the detuning value according to the ramping function such that the detuning value is increased from the second value to a third value; wherein the detuning value is changed by changing the frequency of the gate field and/or the frequency of the motional mode.

The present disclosure relates to an apparatus and method for managing spin-motion entanglement.

### BACKGROUND

Entangling quantum gates in trapped ion systems requires low spin-motion entanglement to achieve high fidelity. It is well known that spin-motion errors are common, being caused and made worse by ion temperature and the like, and it is desirable to reduce these errors accordingly.

It is well known that it is possible to achieve adiabatic elimination of spin-motion entanglement (AESE) by ramping the amplitude of the spin-dependent force (SDF) of a trapped ion. In general, this is done by slowly and smoothly turning the SDF on and off relative to gate detuning.

Current two qubit gates require that at least one mode of the ion crystal is cooled to near ground state in order achieve high fidelities. This limits the speed of fundamental QCCD operations. Thus, it is desirable to provide a method of performing high fidelity two qubit gates at Doppler temperatures and above.

### SUMMARY

According to a first aspect of the disclosure, there is provided a method of performing a quantum operation performed on a quantum device comprising at least one pair of quantum qubit crystals, the method comprising:
setting a detuning value of each qubit crystal to a first value, wherein the detuning value is a difference between a frequency of a gate field of the at least one pair of qubit crystals and a frequency of a motional mode of the at least one pair of qubit crystals;
ramping down the detuning value according to a ramping function such that the detuning value is decreased from the first value to a second value;
ramping up the detuning value according to the ramping function such that the detuning value is increased from the second value to a third value;
wherein the detuning value is changed by changing the frequency of the gate field and/or the frequency of the motional mode.

Optionally, wherein the qubit crystals are entangled by a wire;
wherein a signal is applied to the wire entangling the at least one pair of qubit crystals; and
wherein the signal is a DC voltage for setting a trap potential for the at least one pair of qubit crystals.

Optionally, wherein the frequency of the gate field is changed by changing a frequency of a current passing through the wire.

Optionally, wherein the frequency of the motional mode is changed by changing a DC voltage applied to at least one electrode of the quantum device;
wherein the at least one electrode is configured to generate an electromagnetic field.

Optionally, wherein the frequency of the motional mode is changed by changing at least one of a Radio Frequency, RF, power, RF frequency, or by adding confinement using an optical tweezer.

Optionally, wherein the frequency of the motional mode is changed by changing a frequency or voltage applied to the at least one electrode of the quantum device.

Optionally, wherein the ramping down happens over a first time period;
wherein the ramping up happens over a second time period; and
wherein the first and second time periods are predetermined such that adiabaticity is maintained for the at least one pair of qubit crystals.

Optionally, wherein the detuning value is ramped up after a being held at the second value for a third period of time.

Optionally, wherein the first value is a maximum value.

Optionally, wherein the maximum detuning value is very large relative to a maximum Rabi frequency.

Optionally, wherein a time propagator associated with the quantum operation is:

$$\begin{matrix}U = exp ( \frac{i {ϕ}_{n} {\hat{S}}_{a}^{2}}{2} ) ; \\ wherein {\hat{S}}_{α}^{2} = {\hat{σ}}_{1 α} \pm {\hat{σ}}_{2 α} ;\end{matrix}$$

and
wherein Ŝ_{α} is a collective Pauli operator pointing in a first direction.

Optionally, wherein the quantum operation is a geometric phase gate; and
wherein in the quantum operation is one of an MS gate or a ZZ gate.

Optionally, wherein if the quantum operation is an MS gate, the detuning value is the difference between the frequency of the gate field of the at least one pair of qubit crystals and a total of a qubit frequency and the frequency of the motional mode; and
wherein if the quantum operation is a ZZ gate, the detuning is the difference between the frequency of the gate field of the at least one pair of qubit crystals and the frequency of the motional mode.

Optionally, wherein the electromagnetic field is a near-field magnetic field.

Optionally, wherein the first value and the third value are the same.

According to a second aspect of the disclosure, there is provided an ion trap system comprising an ion trap coupled to a controller.

Optionally, wherein the ion trap comprises at least one pair of qubit crystals.

According to a third aspect of the disclosure, there is provided a quantum device comprising the ion trap system.

### BRIEF DESCRIPTION OF THE DRAWINGS

The disclosure is described in further detail below by way of example and with reference to the accompanying drawings, in which:

FIG. 1 is a block diagram representing a quantum device;

FIG. 2 is a diagram representing an ion trap of a quantum device;

FIG. 3 is a diagram representing a plurality of ion traps of a quantum device;

FIG. 4 is a flowchart representing a method of operating a quantum device;

FIG. 5 is a flowchart representing an example of a method of operating a quantum device; and

FIG. 6 is a graph representing a change in frequency over an operating time of a quantum device.

### DETAILED DESCRIPTION

The present disclosure relates achieving adiabatic elimination of spin-motion entanglement (AESE) for laser-free gate operations of a quantum device comprising at least one pair of entangled ions.

The present disclosure makes reference to “laser-free techniques” which refer to any techniques for operating quantum gates that do not use lasers. Laser-free techniques have significantly less error mechanisms that worsen with temperature.

The present disclosure refers to “adiabatic elimination of spin-motion entanglement (AESE)” which refers to any technique for minimizing or eliminating spin-motion entanglement in the ion traps of the quantum device by changing a quantity slowly such that processes (also referred to as “off resonant processes”) which result in residual spin-motion entanglement are suppressed.

The present disclosure makes reference to “ion traps”, which should be understood to refer to a system wherein a charged particle (for example, a singly charged ion, an electron, a charged molecule or the like) is isolated from an external environment by confining the charged particle using electromagnetic fields. The ion traps may be configured as “ion trap chips” which comprise electrodes configured to generate an electromagnetic field for the purpose of affecting or controlling the trapped ion within the ion trap.

The present disclosure refers to “quantum devices”, which refer to any device which makes use of quantum mechanical properties. For example, a quantum device may be a device which comprises one or more ion traps. For example, the quantum device may be a quantum charge-coupled device (QCCD).

The present disclosure refers to “qubits”, or “quantum bits”, which refer to a quantum mechanical system which is used to encode a basic unit of information. For example, a trapped ion may be considered to be a qubit for a particular quantum device.

The present disclosure refers to “entangled” particles which should be understood to mean “quantum entangled”.

The present disclosure refers to “temperature”, meaning “ion temperatures”. The temperatures referred to within the present disclosure are Doppler temperatures, which may be expressed in terms of an average number of phonons in the crystal mode(s).

The present disclosure refers to “gates”, or “quantum gates” which are quantum operations performed on a quantum device. A quantum gate may be considered to be a kind of logic circuit which utilizes one or more qubits. For example, a two qubit gate may refer to a quantum operation performed using two entangled particles (for example, two entangled qubit crystals). The present disclosure may relate specifically to entangling gates. Specifically, the present disclosure may relate to geometric phase gates such as MS (for XX or YY like, or up/down, interaction) or ZZ (for ZZ, z-axis rotation, interaction).

The present disclosure refers to “gate fields” which are a set of electromagnetic fields (for example, specifically a magnetic field), which interact with internal/external degrees of freedom of a charged particle of the device (for example, a trapped ion). For example, the gate fields may be two gradient fields which are symmetrically detuned from a qubit frequency by approximately a motional mode frequency.

Laser-free techniques for operating quantum devices that use AESE have significant potential for high temperature operations (that is, gate operations which are conducted at relatively high ion temperatures). The present disclosure relates to ramping gate detuning instead of the amplitude of the spin-dependent force.

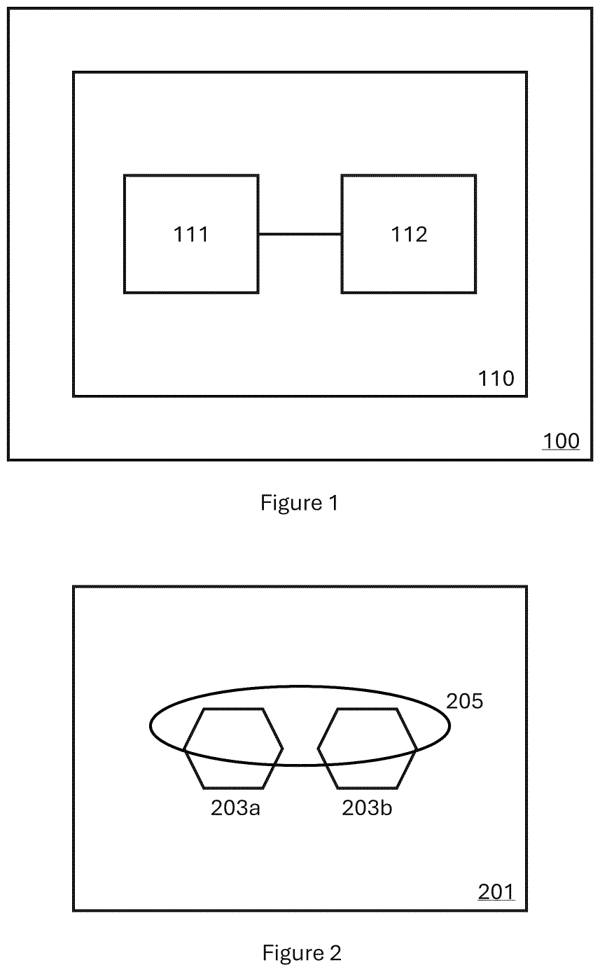

FIG. 1 is a block diagram representing a quantum device 100. The quantum device 100 comprises an ion trap system 110. The ion trap system 110 may comprise an ion trap 111 coupled to a controller 112. The ion trap 111 may comprise at least one pair of qubit crystals.

The quantum device is configured to perform a quantum operation (or “gate”) using the at least one pair of qubit crystals. The quantum operation may be a geometric phase gate. The geometric phase gate may be an MS gate or a ZZ gate.

The ion trap system 110 may further comprise at least one electrode to which a DC voltage may be applied.

An example pair of qubit crystals is illustrated in FIG. 2, which shows an example ion trap 201 comprising two qubit crystals 203a, 203b, which are entangled by a wire 205. The ion trap 201 may be, for example, an ion trap such as ion trap 111 which is part of ion trap system 110 (as illustrated by FIG. 1). The ion trap system 110 may comprise a plurality of ion traps, wherein each ion trap comprises a pair of entangled qubit crystals. Each pair of entangled qubit crystals may be entangled by the same wire.

The wire may be used to apply a signal to the qubit crystals 203a, 203b; the wire is configured to generate an electromagnetic field or, alternatively, a near-field magnetic field. The signal may be a current, wherein the current is used for setting a trap potential for the at least one pair of qubit crystals. That is, the current applied to the wire generates an electromagnetic field, or trap potential, which is used to trap the qubit crystals, which are charged particles.

The current may also be used to control a gate angle of the qubit crystals 203a, 203b. In more detail, the current, and the electromagnetic field it generates in the wire, may be used to control an amount of entanglement (represented by the gate angle) of the pair of qubit crystals 203a, 203b. Thus, the current can be adjusted to adjust the gate angle of the qubit crystals 203a, 203b.

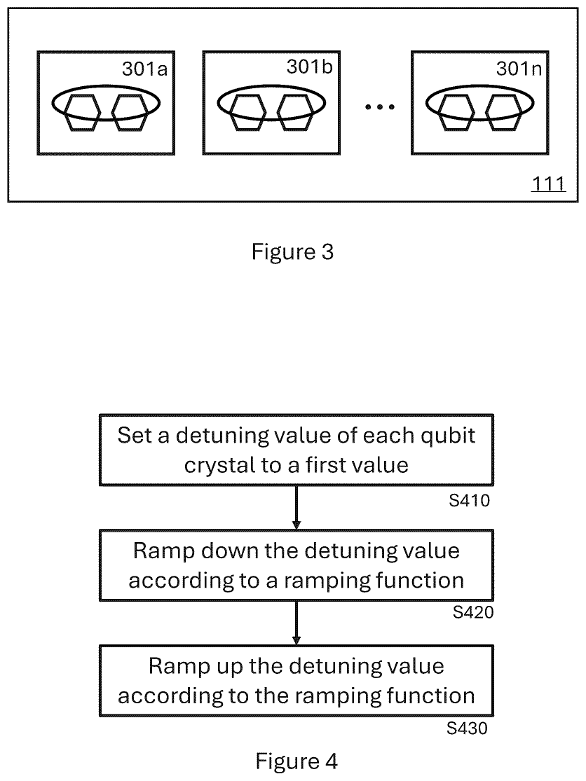

As illustrated in FIG. 3, the ion trap 111 of the quantum device 100 may comprise a plurality of pairs of entangled qubit crystals 301a to 301n (for example, the qubit crystals 203a, 203b as illustrated by FIG. 2).

Each pair of qubit crystals may be entangled by the same wire. That is, a single wire may be used to entangle each pair of qubit crystals.

Alternatively, a plurality of wires may be used to entangle each pair of qubit crystals separately.

FIG. 4 is a flowchart representing a method of managing spin-motion entanglement errors during a quantum operation performed on a quantum device. The quantum device may comprise at least one pair of quantum entangled qubit crystals entangled by a wire and at least one electrode configured to generate an electromagnetic field. The quantum device may be, for example, the quantum device and its components as illustrated by FIGS. 1 to 3.

The flowchart represents a method of maintaining a stable temperature for the quantum device throughout the performance of a gate by changing a detuning value, wherein the detuning value is a difference between two frequency values inherent to the system. Generally, the detuning value may be set to represent a large difference before being changed to represent a small difference and finally reverted to represent a large difference. The detuning value is changed by changing a property of the quantum device; as described below, there are multiple options for which property is changed.

This method is explained in more detail with reference to steps S410 to S430, below.

In step S410, a detuning value of each qubit crystal is set to a first value. The detuning value is a difference between a frequency of a gate field of the at least one pair of qubit crystals and a frequency of a motional mode of the at least one pair of qubit crystals.

The definition of the detuning value may depend on the type of gate being performed. For example, if an MS gate is being performed, it may be necessary for the detuning value to include the qubit frequencies (the frequency/energy associated with a transition between two states being used for the qubit); for the MS gate, the detuning value may be a difference between a frequency of the gate field of the at least one pair of qubit crystals and a sum of the frequency of the motional mode and a qubit frequency of the at least one pair of qubit crystals. Alternatively, if a ZZ gate is being performed, the detuning value may simply be the difference between the frequency of the gate field and the at least one pair of qubit's motional mode frequency.

The frequency of the gate field is a frequency of an oscillation of an electromagnetic field associated with the pair of qubit crystals. The frequency of the motional mode of the at least one pair of qubit crystals is a frequency of an oscillation of collective movement of the qubit crystals.

The first value may be a value representing a maximum difference (a maximum value), or substantially the maximum difference (it need not be an exact maximum value), between the frequency of the gate field and the frequency of the motional mode of the at least one pair of qubit crystals. For example, it may be considered that the value of the gate field and the frequency of the motional mode are both oscillating values. In this case, it may be considered that the first value is the value at a point when the values of the frequency of the gate field and the frequency of the motional mode are furthest away from one another. It should be considered that the maximum difference will vary from device to device depending on calibration and various settings; for example, the maximum value may be chosen based on a bandwidth of motional mode frequencies that is physically convenient to use. The maximum value is not itself important for performing an adiabatic elimination of spin-motion entanglement, it is only necessary for the maximum value to be large enough that the gate is functionally turned off. The maximum value may be very large relative to a maximum Rabi frequency.

In step S420, the detuning value is ramped down according to a ramping function such that the detuning value is decreased from the first value to a second value.

The second value may be a minimum difference, or substantially the minimum difference (it need not be an exact minimum value), between the frequency of the gate field and the frequency of the motional mode of the at least one pair of qubit crystals. It should be considered that the minimum difference will vary depending on the entangling gate angle that is being implemented. This is because the minimum detuning value corresponds to the difference in frequency between the gate field and the motional mode; thus, either value may be used to determine the minimum detuning value. In other words, in any use case, there is a continuum of gate angles that might be implemented, and the minimum detuning value depends on said continuum of gate angles.

The detuning may be ramped from a maximum value to a minimum value.

In step S430, the detuning value is ramped up according to the ramping function such that the detuning value is increased from the second value to a third value. In some examples, the detuning value may only be ramped up after a second time period has elapsed. The second time period is not strictly necessary and instead it may be the case that the detuning value is immediately ramped up from the second value to the third value after it has been ramped down from the first value to the second value.

“Ramping” a value in this context refers to changing (increasing or decreasing) the value by constant amount continuously over the course of a set period of time. That is, ramping may refer to smoothly decreasing the detuning value from the first value (or maximum) to the second value (or minimum) or vice versa.

For example, the detuning value may be ramped (decreased) from a first value to a second value over the course of a first period of time. The detuning value may then be held at the second value for a second period of time. Following the second period of time (if any), the detuning value may be ramped (increased) from the second value to a third value over the course of a third period of time.

The first and third time periods may be set according to an amount of adiabatic elimination is required or desired in the quantum operation. That is, the quantum operation (or gate) may be implemented and a point in the operation at which there is no residual spin-motion entanglement may be determined. That is, when beginning in a state |00>, the point where there is no residual population in |10> or |01> would be determined.

The second time period may be set by the intended gate angle (that is, a gate angle intended to be reached during the quantum operation). The second time period may be set by determining a point of the quantum operation at which there is an equal population in |00> and |11>.

Step S430 ensures that any spin-motion entanglement experienced by the qubit crystals is eliminated at the end of the gate. Ramping the detuning value back up to the third value allows the spin-dependent force to be adiabatically suppressed at the end of the gate. Similarly to a classical mechanical harmonic oscillator experiencing a force, the ramping up to the third value is equivalent to another force bringing the harmonic oscillator to a stop; the ramp depends on a state of the qubit crystals.

In some examples, the third value and the first value may be the same; the third value may represent a maximum difference, or substantially the maximum difference (it need not be an exact maximum value), between the frequency of the gate field and the frequency of the motional mode of the at least one pair of qubit crystals. In these examples, the detuning value may be set to a maximum value before being ramped down to a minimum value and then, after a period of time has elapsed (it should be noted that the detuning value may instead be ramped back up immediately after ramping down), ramped back up to the maximum. In other examples, the third value and first value may be different.

The second time period may be a predefined amount of time determined based on a maximum value of a gate angle of the gate (or quantum operation), wherein the gate angle represents an amount of generated entanglement during the gate. The second time period may be predetermined based on an amount of entanglement generated during the ramp from the first value to the second value; that is, the length of the second time period may be calibrated after the ramp has been performed. Merely as an example, the second time period may be a length of time ranging from zero seconds to 1 ms; for example, an average length for the second time period may be 100 μs.

The detuning value may be changed (ramped up or down, increased or decreased) by changing either of the values which define the detuning value, either the frequency of the gate field or the frequency of the motional mode of the at least one pair of qubit crystals. This may be done by changing at least one property applied to the quantum device.

In order to change the frequency of the gate field, a frequency of the current passing through the wire entangling each pair of qubit crystals is changed. Thus, the property applied to the quantum device that may be changed may be the frequency of the current passing through the wire.

In order to change the frequency of the motional mode of the at least one pair of qubit crystals, a DC voltage applied to at least one electrode of the ion trap system. Thus, the property applied to the quantum device that may be changed may be the DC voltage applied to the at least one electrode. Alternatively, the frequency of the motional mode may be changed by changing a frequency of a signal applied to the at least one electrode (wherein the signal is an alternating current). Alternatively, the motional mode may be changed by changing at least one of a Radio Frequency (RF) power or RF frequency, or by adding confinement using an optical tweezer (a set of finely tuned lasers used to move the trapped ion).

Additionally or alternatively, the motional mode of at least one pair of electrode crystals may be changed by using a laser beam to change the trap potential for the at least one pair of qubit crystals.

The property applied to the quantum device that may be changed may additionally be both the frequency of the current passing through the wire and the trap potential (via DC electrodes, optical tweezers, etc.) to the at least one electrode.

Additionally or alternatively, the property applied to the quantum device that may be changed may be a frequency applied to at least one radio frequency, RF, electrode of the quantum device.

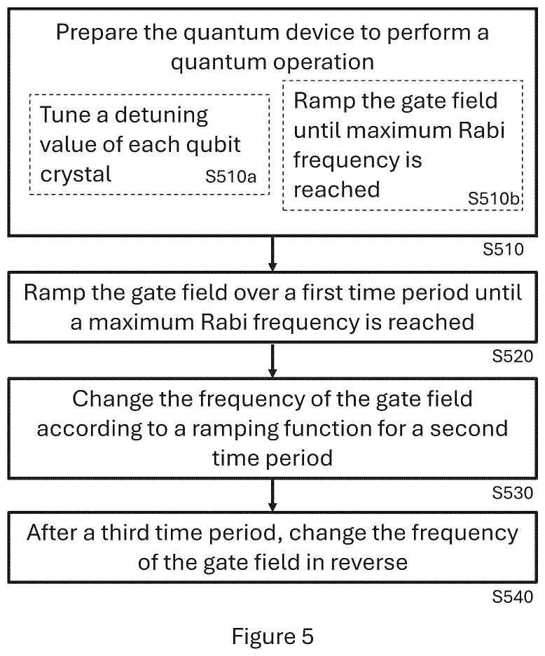

FIG. 5 is a flowchart illustrating a detailed example of how the above-described method may be implemented. In this example, a quantum device such as the device described by reference to FIG. 1 may be considered, performing a geometric phase gate.

In step S510, the quantum device is prepared to perform the quantum operation. The preparation may comprise steps S510a and/or S510b, and may comprise further steps not discussed herein.

In step S510a, a DC voltage is applied to the at least one electrode of the ion trap system in order to tune a minimum detuning value of each qubit crystal (δ_{g,n}). That is, the DC voltage may be applied to determine a minimum detuning value needed to execute a gate angle (φ_{g,n}) on the nth well of the charged particle (for example, a trapped ion). The gate angle represents an amount of entanglement generated during the gate. The subscript “g” stands for gate, while the subscript “n” refers to the “zone” number (a number to indicate the ion trap, or pair of qubit crystals, that the gate angle is associated with). The gate angle may be determined by a mode structure of the qubit crystals, which is controlled by the application of DC voltage to the at least one electrode of the ion trap system.

A time propagator associated with the gate is defined according to equation (1):

$$U = exp ( \frac{i {ϕ}_{n}}{2} ) \qquad ( 1 )$$

Where Ŝ_{α}=\hat{σ}_{1α}+\hat{σ}_{2α} is a collective Pauli operator pointing in a first direction (or direction α), and describes how much entanglement is generated by the gate. For example if the initial state of the system is |00 [symbol] , then U|00 [symbol] =cos (φn)|00 [symbol] +isin (φₙ)|11 [symbol] when α=x.

In step S510b, a frequency of the gate field generated by the wire of the ion trap system is ramped until a maximum Rabi frequency (Ω_{g}) is reached. Thus, the detuning value of the potential well of each ion trap is ramped such that it is much larger than the Rabi frequency (δ_{0,n}»Ω_{g}). This ramping may take place over a time period of 1-5 μs.

In step S520, the frequency of the gate field is then ramped according to a designated ramping function over a first period of time. This ramps the detuning value to a minimum for each potential well of each ion trap. The ramping function may be such that

$$\frac{\dot{δ}}{{δ}^{2}} ≪ 1$$

(that is, the detuning may change at a rate proportional to the magnitude of the detuning value. For example, the detuning value may be changed faster when the magnitude of the detuning is larger). The ramping function is a function of the detuning versus time, and must ramp the detuning value smoothly and at a rate that scales with the detuning. There are many detuning ramping functions that follow this general guideline. One example is:

$$δ ( t ) = \frac{1}{\frac{1}{{δ}_{max}} {cos}^{2} ( \frac{π t}{2 {τ}_{r}} ) + \frac{1}{{δ}_{max}} {sin}^{2} ( \frac{π t}{2 {τ}_{r}} )} ,$$

but there are many such examples. Determining the ‘optimal’ ramping function will be case-dependent.

In step S540, after a second time period has elapsed, the frequency of the gate field is ramped in reverse. That is, the ramping function is applied in reverse such that frequency of the gate field is ramped back up until a maximum Rabi frequency is reached, thus ramping the detuning value to a maximum value. This reverse ramping may take place over a third time period.

The first and third time periods may be determined by a desired value of the gate angle. The longer the first and third time periods are, the less insensitive the gate may be to residual spin-motion entanglement errors. However, a longer first and/or third time period leads to a longer overall gate time. Thus, the first and third time periods are determined such that a balance is found between sensitivity to residual spin-motion entanglement errors and overall gate time. These time periods may also be determined such that the adiabaticity for the gate can be ensured.

It should be understood that the above example may also be modified in order to ramp a DC voltage applied to the at least one electrode of the ion trap system in addition or alternatively to ramping the frequency of current applied to the wire. That is, steps S530 and S540 may also be performed by ramping the DC voltage applied to the at least one electrode in addition or alternatively to ramping the frequency of current applied to the wire.

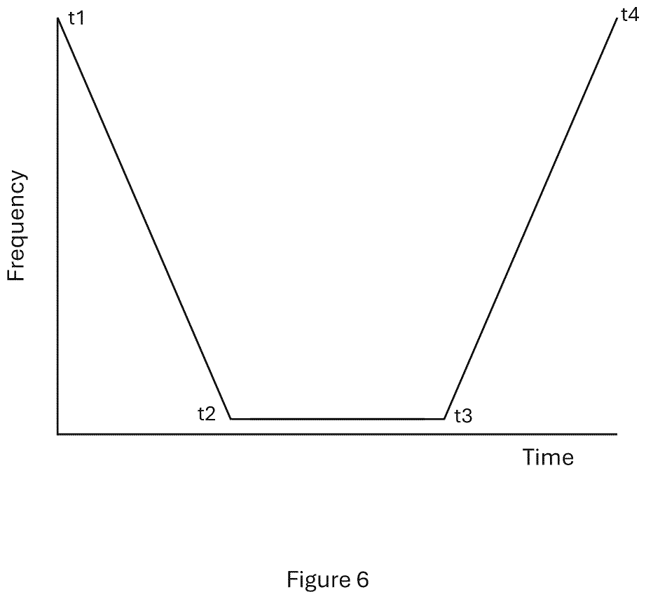

FIG. 6 is a graph showing an example of the ramping of the frequency of the current in the wire as discussed with reference to FIG. 5. It should be understood that the graph is merely exemplary and does not represent specific values.

At time t1, the frequency is ramped from a first value to a second value (representing a minimum value) over the first period of time. The frequency remains at the second value for the second period of time (t2 to t3) before being ramped from the second value back to the first value over a third period of time (t3 to t4). As noted above, it is not necessary to keep the frequency at the second value for the second period of time. In alternative examples, it may be the case that the second value is immediately ramped back to the first value over the third period of time.

The graph demonstrates how the ramping is a smooth and continuous increase/decrease from a first value to a second, which provides a high fidelity method of adiabatically eliminating spin-dependent force.

This has the benefits of achieving AESE quicker than previous work because the average gate detuning is relatively small in comparison to ramping the spin-dependent force. That is, operation speeds may be significantly faster, at gate speed scales of 1/δ, where δ is the gate detuning.

Current two qubit gates require that at least one mode of the ion crystal is cooled to near ground state in order achieve high fidelities. This limits the speed of fundamental QCCD operations.

In comparison, the disclosed method is a laser-free technique, which can be used for high temperature operations, avoiding experimental complexities involved with ramping gradient amplitudes (due to continuously changing AC Zeeman shift), and providing a straightforward way to perform arbitrary angle two qubit gates in parallel without crosstalk.

In more detail, operations at high temperature allows for the reduction of the requirement for sideband cooling, as well as faster transport operations. Additionally, the need for mixed-species transport operations is reduced because of lower cooling requirements. Further, performance is increased and enhanced because no mid-circuit cooling is required.

Other benefits include that greater motional/temperature insensitivity is achieved, meaning that the system is less sensitive to static motional frequency offsets and less sensitive to mode frequency fluctuations with Fourier components below the minimum detuning value; simpler operations are provided because calibration is made simpler and involves tuning time (or detuning) as the only parameter; and temperature insensitivity and motional robustness can be improved by increasing the operating time.

Various improvements and modifications can be made to the above without departing from the scope of the disclosure.

1. A method of performing a quantum operation performed on a quantum device comprising at least one pair of quantum qubit crystals, the method comprising:
setting a detuning value of each qubit crystal to a first value, wherein the detuning value is a difference between a frequency of a gate field of the at least one pair of qubit crystals and a frequency of a motional mode of the at least one pair of qubit crystals;
ramping down the detuning value according to a ramping function such that the detuning value is decreased from the first value to a second value;
ramping up the detuning value according to the ramping function such that the detuning value is increased from the second value to a third value;
wherein the detuning value is changed by changing the frequency of the gate field and/or the frequency of the motional mode.

2. The method of claim 1, wherein the qubit crystals are entangled by a wire;
wherein a signal is applied to the wire entangling the at least one pair of qubit crystals; and
wherein the signal is a DC voltage for setting a trap potential for the at least one pair of qubit crystals.

3. The method of claim 2, wherein the frequency of the gate field is changed by changing a frequency of a current passing through the wire.

4. The method of claim 1, wherein the frequency of the motional mode is changed by changing a DC voltage applied to at least one electrode of the quantum device;
wherein the at least one electrode is configured to generate an electromagnetic field.

5. The method of claim 1, wherein the frequency of the motional mode is changed by changing at least one of a Radio Frequency, RF, power, RF frequency, or by adding confinement using an optical tweezer.

6. The method of claim 1, wherein the frequency of the motional mode is changed by changing a frequency or voltage applied to the at least one electrode of the quantum device.

7. The method of claim 1, wherein the ramping down happens over a first time period;
wherein the ramping up happens over a second time period; and
wherein the first and second time periods are predetermined such that adiabaticity is maintained for the at least one pair of qubit crystals.

8. The method of claim 1, wherein the detuning value is ramped up after a being held at the second value for a third period of time.

9. The method of claim 1, wherein the first value is a maximum value.

10. The method of claim 1, wherein the maximum detuning value is very large relative to a maximum Rabi frequency.

11. The method of claim 1, wherein a time propagator associated with the quantum operation is:
$$\begin{matrix}U = exp ( \frac{i {ϕ}_{n} {\hat{S}}_{a}^{2}}{2} ) ; \\ wherein {\hat{S}}_{α} = {\hat{σ}}_{1 α} \pm {\hat{σ}}_{2 α} ;\end{matrix}$$
and
wherein Ŝ_{α} is a collective Pauli operator pointing in a first direction.

12. The method of claim 1, wherein the quantum operation is a geometric phase gate; and wherein in the quantum operation is one of an MS gate or a ZZ gate.

13. The method of claim 12, wherein if the quantum operation is an MS gate, the detuning value is the difference between the frequency of the gate field of the at least one pair of qubit crystals and a total of a qubit frequency and the frequency of the motional mode; and
wherein if the quantum operation is a ZZ gate, the detuning is the difference between the frequency of the gate field of the at least one pair of qubit crystals and the frequency of the motional mode.

14. The method of claim 4, wherein the electromagnetic field is a near-field magnetic field.

15. The method of claim 1, wherein the first value and the third value are the same.

16. An ion trap system comprising an ion trap coupled to a controller configured to perform the method of claim 1.

17. The ion trap system of claim 16, wherein the ion trap comprises at least one pair of qubit crystals.

18. A quantum device comprising the ion trap system of claim 16.
